(19) United States
(12) Patent Application Publication
(10) Pub. No.: US 2025/0102041 A1
(43) Pub. Date: Mar. 27, 2025

(54) DAMPER VALVE AND VIBRATION DAMPER

(71) Applicants: thyssenkrupp Bilstein GmbH, Ennepetal (DE); thyssenkrupp AG, Essen (DE)

(72) Inventor: Martin FLICK, Gummersbach (DE)

(73) Assignees: thyssenkrupp Bilstein GmbH, Ennepetal (DE); thyssenkrupp AG, Essen (DE)

(21) Appl. No.: 18/891,174

(22) Filed: Sep. 20, 2024

(30) Foreign Application Priority Data
Sep. 25, 2023 (DE) 10 2023 125 837.0

(51) Int. Cl. F16F 9/46; B60G 17/08

(52) U.S. Cl. CPC F16F 9/467; B60G 17/08

(57) ABSTRACT

A damper valve for a vibration damper, in particular of a vehicle, comprises a valve body, at least one control disc arranged on the valve body, and at least one rotatably mounted adjustment element, wherein the valve body, the control disc and the adjustment element are arranged coaxially, and wherein the control disc is connected to the adjustment element for conjoint rotation and the control disc is rotatable relative to the valve body in order to open up or block at least one of a plurality of through-channels in the valve body for the flow of a damper fluid, wherein the control disc has at least two through-openings with different cross sections, in order to change the flow of the damper fluid, in particular the flow cross section, through the through-channels in the valve body.

### CROSS REFERENCE TO RELATED APPLICATION

This application is a U.S. Non-Provisional that claims priority to German Patent Application No. DE 10 2023 125 837.0, filed Sep. 25, 2023, and the entire content of which is incorporated herein by reference.

### FIELD

The disclosure relates to a damper valve for a vibration damper and to a vibration damper having at least one damper valve.

### BACKGROUND

Precise and easy regulation of the damping force is important in particular in the motorsports sector. There, shock absorbers with a variable damping force usually have switchable valve devices with which, for example, additional connecting channels in the piston can be opened and closed in order to change the damping force. A vibration damper of this kind, for example, having a settable damping force is known from DE 20 2014 102 888 U1 mentioned at the beginning. However, a drawback is that the vibration damper has an adjustable piston valve having a complex adjustment mechanism.

Thus a need exists for specifying a damper valve which allows easy and precise setting of the damping force. Furthermore, the disclosure relates to specifying a vibration damper having such a damper valve.

### BRIEF DESCRIPTION OF THE FIGURES

Further advantageous features and details of the disclosure will be explained in more detail in the context of the embodiments illustrated in the figures, in which:

FIG. 1 shows a section through a vibration damper having a damper valve according to one exemplary embodiment.

FIG. 2 shows a perspective illustration of a damper valve according to FIG. 1.

FIG. 3 shows a section through a damper valve according to FIG. 1.

FIG. 4 shows a plan view of a valve body of a damper valve according to FIG. 1, wherein the through-channels are clearly visible.

FIGS. 5-14 show a plan view of the control disc of a damper valve according to FIG. 1 in different rotational positions.

### DETAILED DESCRIPTION

Some embodiments include a damper valve for a vibration damper, in particular of a vehicle, having a valve body, at least one control disc arranged on the valve body, and at least one rotatably mounted adjustment element, wherein the valve body, the control disc and the adjustment element are arranged coaxially, and wherein the control disc is connected to the adjustment element for conjoint rotation. The control disc is rotatable relative to the valve body in order to open up or block at least one of a plurality of through-channels in the valve body for the flow of a damper fluid. The control disc has at least two through-openings with different cross sections Q, in order to change the flow of the damper fluid, in particular the flow cross section, through the through-channels in the valve body.

The embodiments described herein have various advantages. The damper valve makes it possible to set the damping force of a vibration damper, in particular before a vehicle is used for racing, in that the flow of the damper fluid through the damper valve is variable. In other words, the damping is adaptable to the driving situation, or selectively settable to be soft or hard. Therefore, the damper valve is advantageously usable in particular in the motorsports sector since precise setting of the damping for example for different track characteristics and driving styles of the drivers are able to be realized in a simple manner. In addition, the through-channels in the valve body can be moved so as to overlap with the through-openings in the control disc by rotating the control disc. In this case, as many through-openings as desired can be fluidically connected to the through-channels in the valve body. If all the through-openings are opened up, the damping is set to be particularly soft. The hardest damping is achieved by closing all the through-openings.

Advantageously, the flow of the damper fluid through the valve body is changed by changing the flow cross section. To this end, the through-openings in the control disc have different cross sections Q. Changing the flow cross section comprises, within the meaning of the present disclosure, both the through-openings being fully closed, in which no damper fluid passes through the through-openings, and the through-openings being fully open, in which the damper fluid flows, unimpeded, through all the through-openings. Furthermore, the control disc is designed in such a way as to take up any desired intermediate position between the through-openings being fully open or fully closed.

It is particularly advantageous that the damper valve allows the bypass flow in a vibration damper to be changed. Within a vibration damper, the damper valve can be provided in order to allow the damper fluid to flow between working spaces of the vibration damper which are separated by a working piston, bypassing a piston valve of the working piston. In other words, a bypass fluidic connection can be created, through which a partial flow of the damping medium through the damper valve is guided past the piston valve. In this case, the partial flow of the damper fluid through the damper valve can be set in order to adapt the operating characteristics of the vibration damper in a targeted manner before the vehicle is used for racing.

It is also advantageous that the damper valve allows the bypass to be fully closed. This is achievable when all the through-openings in the control disc are blocked and consequently the bypass flow or the partial flow of the damper fluid through the damper valve is substantially equal to zero.

Also advantageously, it is possible to adjust the damping force in equal steps. To this end, the control disc is rotatable relative to the valve body by the adjustment element. In other words, the control disc is advantageously actuable via the adjustment element. In this case, the control disc is able to be rotated in equal steps with the aid of the adjustment element. Put another way, the rotation of the control disc from one position into the next takes place advantageously uniformly.

Furthermore, the damper valve, in particular the control disc of the damper valve, is able to be produced easily and precisely with at least two through-openings. This should preferably be understood as meaning that the effect of errors on account of tolerances in the manufacture of the damper valve is advantageously limited only to the precision of the at least two through-openings in the control disc.

Specifically, the damper valve is used in a vibration damper for motorsports vehicles, in particular for racing cars or sportscars. Other applications are possible.

Preferably, the control disc is able to be moved into different rotational positions, wherein, depending on the rotational position of the control disc, one or more of the through-channels in the valve body are opened up or blocked for the flow of the damper fluid. In other words, the control disc is in the form of a central switching disc which allows different switching positions in order to set the damping force of the vibration damper. Here, it is advantageous that the control disc has a simple structure which allows the setting of different rotational positions. Furthermore, the switching of the control disc is fail-safe since it is not possible to over-rotate the control disc. In this way, operating errors can be avoided.

Furthermore, the through-channels in the valve body are preferably able to be selected and/or blocked by the control disc in such a way that, in at least one direction of rotation of the control disc, the flow cross sections of the through-openings are added together or subtracted from one another. This should preferably be understood as meaning that rotation of the control disc in the clockwise or anticlockwise direction results in particular through-openings being opened up or blocked. The factor by which the flow cross section changes in one direction of rotation of the control disc can in this case be different from one rotational position to the next. In this case, the adding together of the flow cross sections advantageously results in softer damping. As a result of the flow cross sections being subtracted from one another, harder damping can be achieved. This advantageously allows the flow cross section and thus the damping force to be adapted incrementally.

In a further preferred embodiment, the number of rotational positions of the control disc corresponds to the square of the number of through-openings in the control disc. If the control disc has, for example, four through-openings, the control disc is able to be moved into sixteen rotational positions. Since the preferably four through-openings in the control disc have different cross sections, the flow cross section through the through-channels in the valve body can be changed in sixteen rotational positions. In the following table, by way of example, sixteen rotational positions are illustrated, the flow cross sections of which are settable by the blocking or opening up of four through-openings with different flow cross sections.

| | Through- | Through- | Through- | Through- | Flow cross |
|---|---|---|---|---|---|
| Rotational | opening 1 | opening 2 | opening 3 | opening 4 | section |
| position | [mm2] | [mm2] | [mm2] | [mm2] | [mm2] |
| 1 | | | | | 0 |
| 2 | 0.2 | | | | 0.2 |
| 3 | | 0.4 | | | 0.4 |
| 4 | 0.2 | 0.4 | | | 0.6 |
| 5 | | | 0.8 | | 0.8 |
| 6 | 0.2 | | 0.8 | | 1 |
| 7 | | 0.4 | 0.8 | | 1.2 |
| 8 | 0.2 | 0.4 | 0.8 | | 1.4 |
| 9 | | | | 1.6 | 1.6 |
| 10 | 0.2 | | | 1.6 | 1.8 |
| 11 | | 0.4 | | 1.6 | 2 |
| 12 | 0.2 | 0.4 | | 1.6 | 2.2 |
| 13 | | | 0.8 | 1.6 | 2.4 |
| 14 | 0.2 | | 0.8 | 1.6 | 2.6 |
| 15 | | 0.4 | 0.8 | 1.6 | 2.8 |
| 16 | 0.2 | 0.4 | 0.8 | 1.6 | 3 |

Furthermore, the rotational positions of the control disc are advantageously settable incrementally by the adjustment element, wherein the control disc is able to be moved into at least 4, in particular 6 to 14, preferably at least 16 rotational positions. Here, it is advantageous that the damper valve is usable for different areas of application as a result of a variable number of rotational positions. Particularly preferably, the control disc is able to be moved into 10 rotational positions. Furthermore, it is advantageous that a multiplicity of different rotational positions allows improved settability of the damping.

Preferably, the through-openings in the control disc and/or the through-channels in the valve body are arranged on different hole circles, in particular on two different hole circles. This should preferably be understood as meaning that the through-openings in the control disc and/or the through-channels in the valve body are arranged on different circles with different radii, the midpoints of which are arranged at the centre of the adjustment element.

Particularly preferably, the through-openings in the control disc and/or the through-channels in the valve body are arranged on two different hole circles. With regard to the control disc, in each case two through-openings can preferably be arranged on the same hole circle. As a result of this structured arrangement of the through-openings and through-channels, a compact overall size of the damper valve, in particular of the control disc and of the valve body, is able to be realized.

Also preferably, the through-openings in the control disc and the through-channels in the valve body which are arranged on the same hole circle may correspond or be spaced apart from one another depending on the rotational position of the control disc. In other words, one or more of the through-openings in the control disc can, in different rotational positions, be superimposed on the through-channels in the valve body. Put another way, the through-openings in the control disc and the through-channels in the valve body overlap in different rotational positions. This should preferably be understood as meaning that the through-openings in the control disc and the through-channels in the valve body cooperate in order to allow a flow through the damper valve.

Furthermore, at least two of the through-channels in the valve body may have different flow cross sections. In other words, the through-channels in the valve body may have different sizes. In this case, the through-channels may be designed in a round or circular manner or be in the form of a slot. Here, it is advantageous that the different cross sections of the through-channels are easy to produce.

In a further preferred embodiment, at least one or more through-channels in the valve body extend outwardly in a radial direction. This should be understood as meaning that some of the through-channels in the valve body can extend over more than one hole circle. Particularly preferably, some through-channels extend over two hole circles. This is advantageous in order to allow a high number of rotational positions.

Furthermore, the control disc is preloaded or able to be preloaded against the valve body by at least one spring element. As a result, the control disc can be preloaded in a simple manner against the valve body in order to ensure a reliable flow from the control disc through the valve body.

Preferably, at least one actuating part is connected to the adjustment element for conjoint rotation, wherein the actuating part is accessible from the outside and is preferably rotatable by hand. In other words, the control disc can be moved into different rotational positions by the actuating part. Here, it is advantageous that the flow cross section through the valve body can be changed easily by the setting of a different rotational position with the aid of the actuating part. Consequently, a desired damping action is easily settable. It is also advantageous that the actuating part allows force-free actuation. Furthermore, the rotation of the control disc can advantageously take place without tools.

Furthermore, the adjustment element is advantageously in the form of an adjustment shaft which extends through the valve body and the control disc, wherein the control disc is arranged on the adjustment shaft for conjoint rotation and the valve body is rotationally decoupled from the adjustment shaft. This should preferably be understood as meaning that the control disc, upon actuation of the adjustment shaft, advantageously follows the rotation of the adjustment shaft. Furthermore, the valve body is preferably arranged in a stationary manner. As a result of this arrangement of the control disc and of the valve body on the adjustment shaft, it is easy to ensure that the control disc is rotatable relative to the valve body and consequently can take up different rotational positions in order to change the flow through the valve body.

In a further preferred embodiment, at least one holding part is provided, into which the valve body is at least partially inserted, wherein the adjustment element extends through the holding part. Here, it is advantageous that the holding part serves both for fixedly receiving the valve body and for rotatably mounting the adjustment shaft.

Some embodiments relate to a vibration damper for a motorized vehicle, having at least one damper valve as described herein, wherein the damper valve is fluidically connected or able to be fluidically connected to at least one working space and/or a compensation space of the vibration damper in order to set a damping force.

Embodiments are explained in more detail in the following text by way of further details with reference to the attached drawings. The illustrated exemplary embodiments represent examples of how the damper valve described herein and the vibration damper described herein can be configured.

In the following text, the same reference signs will be used for identical or identically acting parts.

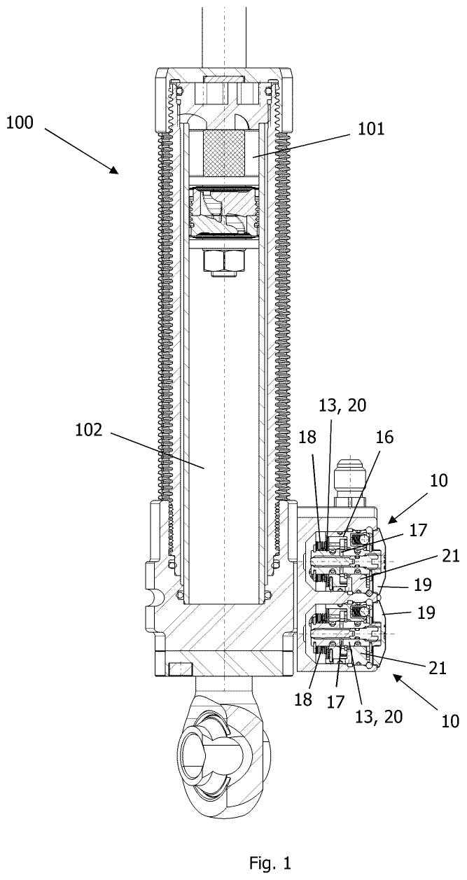

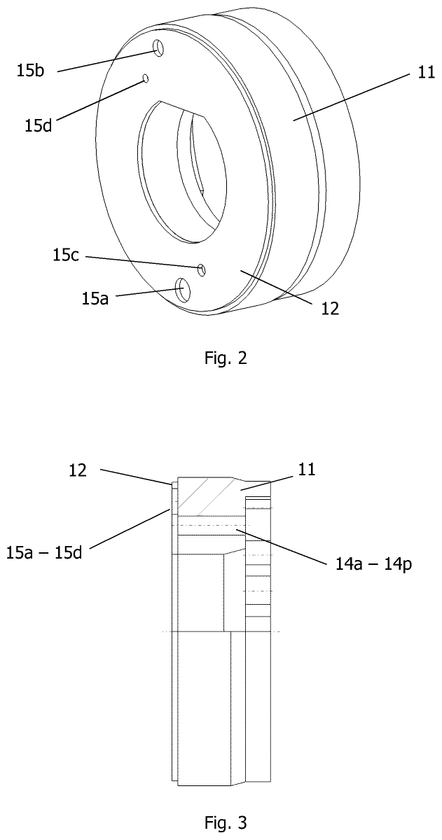

FIG. 2 shows an exemplary embodiment of a damper valve 10 for a vibration damper 100. FIG. 1 shows, for example, a vibration damper 100 on which the damper valve 10 is used. This use is the application of the damper valve 10 in a vibration damper 100 for a motorized vehicle. Specifically, the damper valve 10 is used in a vibration damper 100 for motorsports vehicles, in particular for racing cars or sportscars. Other applications are possible.

FIGS. 2 and 3 show that the damper valve 10 has a valve body 11. The valve body 11 is designed in the form of a disc or in a rotationally symmetric manner. It is also apparent that the valve body 11 is able to be flowed through by a damper fluid.

It is also clear from FIGS. 2 and 3 that a control disc 12 is arranged on the valve body 11 of the damper valve 10. The control disc 12 is oriented coaxially with the valve body 11. Specifically, the control disc 12 lies directly on the valve body 11 and is in this case designed to allow a damper fluid to flow through the valve body 11 or to block this.

In FIG. 1, it can be seen that a rotatably mounted adjustment element 13 is provided in the damper valve 10. The adjustment element 13 serves for actuating the adjustment mechanism of the damper valve 10, i.e. the damping force is settable via the adjustment element 13. Specifically, the adjustment element 13 extends through the valve body 11 and the control disc 12. To this end, the valve body 11 and the control disc 12 have, in their middle, an opening. It is also apparent that the adjustment element 13 is arranged coaxially with the valve body 11 and the control disc 12.

As is illustrated in FIG. 1, the control disc 12 is connected to the adjustment element 13 for conjoint rotation. Consequently, the control disc 12 is connected to the adjustment element 13 such that a rotary movement of the adjustment element 13 is transferable to the control disc 12.

Furthermore, the control disc 12 shown in FIGS. 2 and 3 is rotatable relative to the valve body 11. In this case, the valve body 11 is arranged in a stationary manner. The control disc 12 is rotatable relative to the valve body 11.

Moreover, the valve body 11 has multiple through-channels 14a-14p for the flow of a damper fluid. In other words, the valve body 11 is able to be flowed through by the damper fluid via the through-channels 14a-14 p. Specifically, the valve body 11 comprises sixteen through-channels 14a-14 p. A different number of through-channels 14a-14p is possible. The number of through-channels 14a-14p is generally able to be matched to the desired number of rotational positions of the damper valve 10.

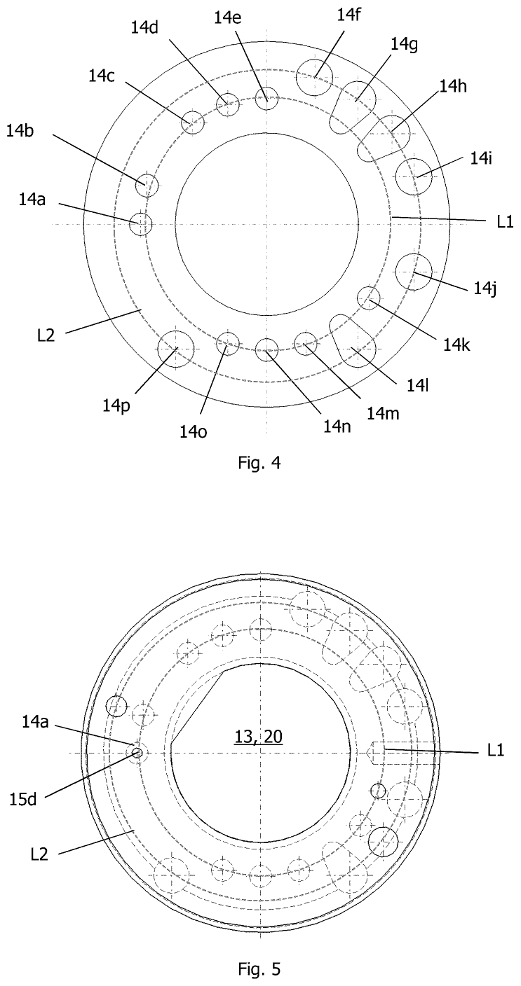

Furthermore, the through-channels 14a-14p may have different designs. It is apparent from FIG. 4 that the through-channels 14a-14p are in the form of bores with different diameters and/or shapes.

It is clear from FIG. 2 that the control disc 12 has four through-openings 15a-15d with different cross sections Q. Specifically, the four through-openings 15a-15d have a cross section of 0.2 mm2, 0.4 mm2, 0.8 mm2 and 1.6 mm2, respectively. As a result, the flow cross section of the damper fluid through the valve body 11 and the through-channels 14a-14p in the valve body 11 is variable.

It is apparent from FIGS. 5 to 14 that the control disc 12 is able to be moved into different rotational positions, wherein, depending on the rotational position of the control disc 12, one or more of the through-channels 14a-14p in the valve body 11 are opened up or blocked for the flow of the damper fluid. Specifically, FIGS. 5 to 14 illustrate ten different rotational positions, wherein a different flow of the damper fluid through the damper valve 10 is realized in each case. In other words, different through-openings 15a-15d and through-channels 14a-14p overlap one another in the different rotational positions.

FIG. 5 shows that the through-opening 15d in the control disc 12 is overlapping the through-channel 14a in the valve body 11. In other words, the through-channel 14a has been opened up for the flow of the damper fluid. It is also apparent that the through-channels 14b to 14h have been blocked for the flow of the damper fluid. The flow cross section through the damper valve 10 results, in this rotational position of the control disc 12, from the cross section of the through-opening 15d. Specifically, the through-opening 15d has a flow cross section of 0.2 mm2. Consequently, the flow cross section through the damper valve 10 is 0.2 mm2.

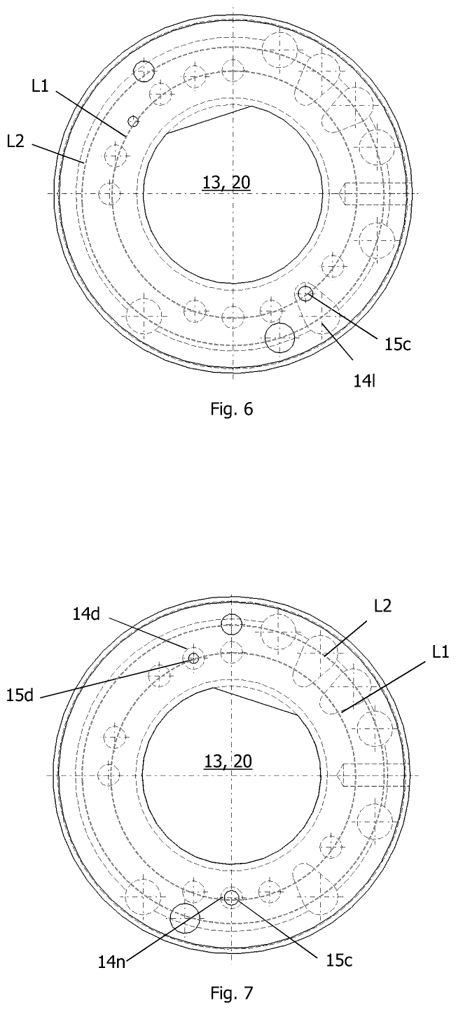

Furthermore, FIG. 6 shows that the through-opening 15c in the control disc 12 is overlapping the through-channel 14l in the valve body 11. In other words, the through-channel 14l has been opened up for the flow of the damper fluid. The remaining through-channels 14a to 14k and 14m to 14p have been blocked for the flow of the damper fluid. The flow cross section through the damper valve 10 results, in this rotational position of the control disc 12, from the cross section of the through-opening 15c, which has a flow cross section of 0.4 mm2.

In FIG. 7, it can be seen that the through-opening 15d in the control disc 12 is overlapping the through-channel 14d in the valve body 11 and the through-opening 15c is overlapping the through-channel 14n. In other words, the through-channels 14d and 14n have been opened up for the flow of the damper fluid. The flow cross section through the damper valve 10 results, in this rotational position of the control disc 12, from the cross sections of the through-openings 15c and 15d being added together. Specifically, the through-opening 15c has a flow cross section of 0.4 mm2 and the through-opening 15d has a flow cross section of 0.2 mm2. Consequently, the flow cross section through the damper valve 10 is 0.6 mm2.

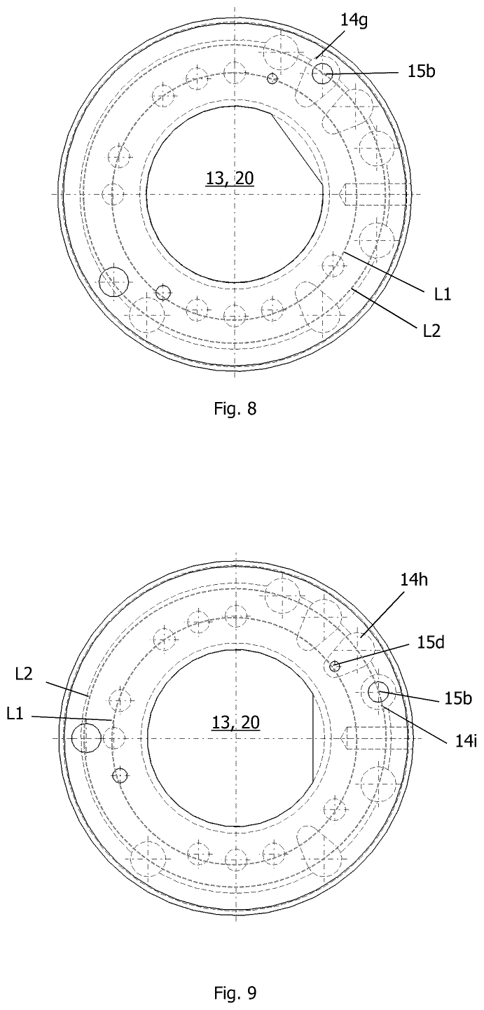

FIG. 8 illustrates that the through-opening 15b in the control disc 12 is overlapping the through-channel 14g in the valve body 11. In other words, the through-channel 14g has been opened up for the flow of the damper fluid. The flow cross section through the damper valve 10 results, in this rotational position of the control disc 12, from the cross section of the through-opening 15b, which has a flow cross section of 0.8 mm2.

FIG. 9 shows that the through-opening 15d in the control disc 12 is overlapping the through-channel 14h in the valve body 11 and the through-opening 15b is overlapping the through-channel 14i. In other words, the through-channels 14h and 14i have been opened up for the flow of the damper fluid. The flow cross section through the damper valve 10 results, in this rotational position of the control disc 12, from the cross sections of the through-openings 15b and 15d, which have a flow cross section of 0.8 mm2 and 0.2 mm2, respectively, being added together. Consequently, the flow cross section through the damper valve 10 is 1 mm2.

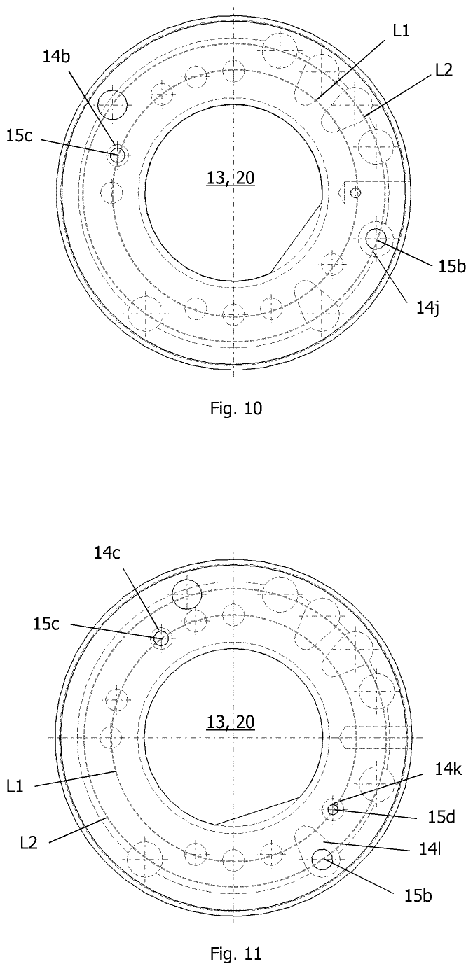

Furthermore, FIG. 10 shows that the through-opening 15c in the control disc 12 is overlapping the through-channel 14b in the valve body 11 and the through-opening 15b is overlapping the through-channel 14j. In other words, the through-channels 14b and 14j have been opened up for the flow of the damper fluid. The flow cross section through the damper valve 10 results, in this rotational position of the control disc 12, from the cross sections of the through-openings 15b and 15c, which have a flow cross section of 0.8 mm2 and 0.4 mm2, respectively, being added together. Consequently, the flow cross section through the damper valve 10 is 1.2 mm2.

FIG. 11 illustrates that the through-opening 15b in the control disc 12 is overlapping the through-channel 14l in the valve body 11, the through-opening 15c is overlapping the through-channel 14c and the through-opening 15d is overlapping the through-channel 14k. In other words, the through-channels 14c, 14k and 14l have been opened up for the flow of the damper fluid. The flow cross section through the damper valve 10 results, in this rotational position of the control disc 12, from the cross sections of the through-openings 15b, 15c and 15d being added together. The flow cross section through the damper valve 10 is 1.4 mm2 in this rotational position.

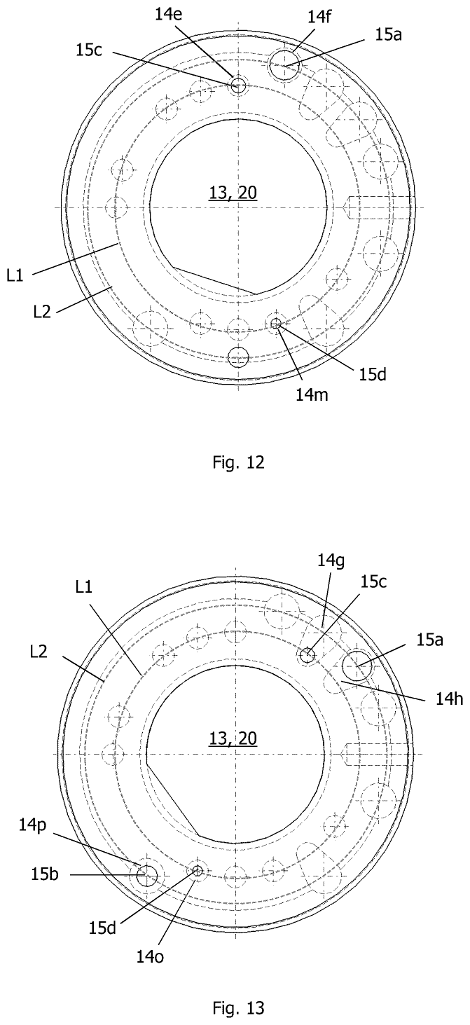

In FIG. 12, it can be seen that the through-opening 15a in the control disc 12 is overlapping the through-channel 14f in the valve body 11, the through-opening 15c is overlapping the through-channel 14e and the through-channel 15d is overlapping the through-channel 14m. In other words, the through-channels 14e, 14f and 14m have been opened up for the flow of the damper fluid. The flow cross section through the damper valve 10 results, in this rotational position of the control disc 12, from the cross sections of the through-openings 15a, 15c and 15d being added together. Consequently, the flow cross section through the damper valve 10 is 2.2 mm2.

It is clear from FIG. 13 that the through-opening 15a in the control disc 12 is overlapping the through-channel 14h in the valve body 11, the through-opening 15b is overlapping the through-channel 14p, the through-opening 15c is overlapping the through-channel 14g and the through-opening 15d is overlapping the through-channel 14o. In other words, the through-channels 14g, 14h, 14o and 14p have been opened up for the flow of the damper fluid. The flow cross section through the damper valve 10 results, in this rotational position of the control disc 12, from the cross sections of the through-openings 15a, 15b, 15c and 15d being added together. Consequently, the flow cross section through the damper valve 10 is 3 mm2. In this specific case, the damping is set at its softest level. This should preferably be understood as meaning that the bypass flow is set to maximum.

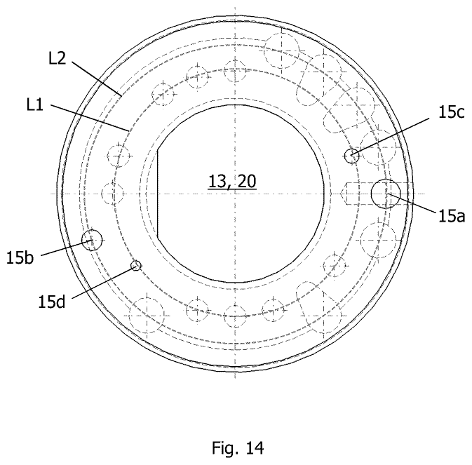

FIG. 14 shows that none of the through-openings 15a-15d in the control disc 12 is overlapping a through-channel 14a-14p in the valve body 11. Consequently, none of the through-channels 14a-14p has been opened up for the flow of the damper fluid. In other words, all of the through-channels 14a-14p have been blocked for the flow of the damper fluid. The flow cross section through the damper valve 10 is 0 mm2 in this rotational position. In this specific case, the damping is set at its hardest level. This should preferably be understood as meaning that the bypass flow is equal to zero.

It is also clear from FIGS. 5 to 14 that the through-channels 14a-14p in the valve body 11 are preferably able to be selected or blocked by the control disc 12 such that, in at least one direction of rotation of the control disc 12, the flow cross sections of the through-openings 15a-15d are added together or subtracted from one another. This situation is explained in more detail in the following text by way of example with reference to FIGS. 9 and 10. FIG. 9 shows a flow cross section through the damper valve 10 of 1 mm2, which results from the cross sections of the through-openings 15b and 15d, which have a flow cross section of 0.8 mm2 and 0.2 mm2, respectively, being added together. As a result of the control disc 12 illustrated in FIG. 9 being rotated in the clockwise direction, the rotational position illustrated in FIG. 10 is achieved. FIG. 10 shows a flow cross section through the damper valve 10 of 1.2 mm2, which results from the cross sections of the through-openings 15b und 15c, which have a flow cross section of 0.8 mm2 and 0.4 mm2, respectively, being added together. Consequently, the flow cross sections of the through-openings 15a-15d are added together when the control disc 12 is rotated in the clockwise direction. Conversely, the flow cross sections are subtracted from one another upon rotation in the anticlockwise direction.

Furthermore, it can be seen in FIGS. 5 to 14 that the number of rotational positions of the control disc 12 corresponds to the square of the number of through-openings 15a-15d in the control disc 12. This should be understood as meaning that, with four through-openings 15a-15d, sixteen rotational positions are achievable. However, it is not absolutely necessary for all possible rotational positions to be implemented in the damper valve 10. In the specific exemplary embodiment according to FIGS. 5 to 14, ten rotational positions are able to be implemented. Since the control disc 12 has four through-openings 15a-15d, it is alternatively possible for up to sixteen rotational positions to be able to be implemented.

Moreover, FIG. 1 illustrates that the rotational positions of the control disc 12 are settable incrementally by the adjustment element 13. Specifically, the control disc 12 is able to be moved into ten rotational positions. A different number of rotational positions is possible.

It is apparent from FIGS. 5 to 14 that the through-openings 15a-15d in the control disc 12 and the through-channels 14a-14p in the valve body 11 are arranged on two different hole circles L1, L2. It is possible for the through-openings 15a-15d and the through-channels 14a-14p to be arranged in a manner distributed between more than two hole circles L1, L2. For example, the through-openings 15a-15d and through-channels 14a-14p can be arranged in a manner distributed over 3, 4 or 5 hole circles L1, L2.

FIGS. 5 to 14 also show that the through-openings 15a-15d in the control disc 12 and the through-channels 14a-14p in the valve body 11 which are arranged on the same hole circle L1, L2 correspond or are spaced apart from one another depending on the rotational position of the control disc 12. For example, it can be seen in FIG. 10 that the through-opening 15b corresponds to the through-channel 14j, i.e. is overlapping the latter. In this case, the through-opening 15b and the through-channel 14j are arranged on the same hole circle L2. It can also be seen in FIG. 10 that the through-opening 15c corresponds to the through-channel 14b, i.e. is overlapping the latter. In this case, the through-opening 15c and the through-channel 14b are arranged on the same hole circle L1. FIG. 10 also shows that the remaining through-channels 14a, 14c to 14i and 14k to 14p, which are located on one of the two hole circles L1, L2 or extend over both hole circles L1, L2, are spaced apart from the through-openings 15a-15d in the control disc 12.

It is clear from FIG. 4 that the through-channels 14a-14p in the valve body 11 have different flow cross sections. In other words, the through-channels 14a-14p in the valve body 11 can be different sizes or have different shapes. Specifically, three of the sixteen through-channels 14g, 14h, 14l are in the form of slots, which have a larger cross section than the remaining through-channels 14a to 14f, 14i to 14k and 14m to 14p.

FIG. 4 also illustrates that three of the through-channels 14g, 14h, 14l in the valve body 11 extend outwardly in a radial direction. Specifically, these through-channels 14g, 14h, 14l extend over both hole circles L1, L2 and are in the form of slots. Alternatively, it is possible for the through-channels 14a-14p to be arranged only on one hole circle L1, L2. In this case, it is possible for two or more through-channels 14a-14p to be arranged close together on different hole circles L1, L2 along a straight line which extends through the midpoint of the valve body 11.

As is illustrated in FIG. 1, the control disc 12 is preloaded against the valve body 11 by a spring element 18. It is possible for the control disc 12 to be preloaded or to be able to be preloaded by some other element. In general, customary spring elements 18 are suitable for preloading the control disc 12 against the valve body 11.

It can be seen in FIG. 1 that an actuating part 19 is connected to the adjustment element 13 for conjoint rotation. Consequently, a rotary movement of the actuating part is transferable to the adjustment element. Furthermore, the actuating part 19 is accessible from the outside and rotatable by hand. Put another way, the actuating part 19 is reachable and manually operable without tools.

It is also apparent from FIG. 1 that the adjustment element 13 is in the form of an adjustment shaft 20, which extends through the valve body 11 and the control disc 12. In this case, the control disc 12 is arranged on the adjustment shaft 20 for conjoint rotation. It is apparent that the control disc 12, upon actuation of the adjustment shaft 20, follows the rotation of the adjustment shaft 20. Furthermore, the valve body 11 is rotationally decoupled from the adjustment shaft 20 and arranged in a stationary manner.

It can furthermore be seen in FIG. 1 that a holding part 21 is provided, into which the valve body 11 is inserted, wherein the adjustment element 13 extends through the holding part 21.

FIG. 1 shows a vibration damper 100 for a motorized vehicle, having four damper valves 10, wherein the damper valves 10 are fluidically connected or able to be fluidically connected to at least one working space 101, 102 and/or a compensation space of the vibration damper 100 in order to set a damping force. This should preferably be understood as meaning that the damper valves 10 are provided to allow the damper fluid to flow between working spaces 101, 102 of the vibration damper 100 which are separated from one another by a working piston, bypassing a piston valve of the working piston. In other words, the damper valves 10 create a bypass fluid connection, through which a partial flow of the damping medium through the damper valves 10 is guided past the piston valve.

Specifically, the vibration damper 100 according to FIG. 1 has two damper valves 10, which are arranged laterally on the vibration damper 100. In this case, in each case one damper valve 10 is provided for the rebound stage or pressure stage of the vibration damper 100.

### LIST OF REFERENCE SIGNS

10 Damper valve
11 Valve body
12 Control disc
13 Adjustment element
14a-14p Through-channels
15a-15d Through-openings
L1, L2 Hole circles
18 Spring element
19 Actuating part
20 Adjustment shaft
21 Holding part
100 Vibration damper 101, 102 Working space

What is claimed is:

1. A damper valve for a vibration damper, comprising:
a valve body;
at least one control disc arranged on the valve body; and
at least one rotatably mounted adjustment element;
wherein the valve body, the control disc and the adjustment element are arranged coaxially;
wherein the control disc is connected to the adjustment element for conjoint rotation and the control disc is rotatable relative to the valve body in order to open up or block at least one of a plurality of through-channels in the valve body for the flow of a damper fluid;
wherein the control disc has at least two through-openings with different cross sections, in order to change the flow of the damper fluid through the through-channels in the valve body.

2. The damper valve according to claim 1, wherein the control disc is able to be moved into different rotational positions, wherein, depending on the rotational position of the control disc, one or more of the through-channels in the valve body are opened up or blocked for the flow of the damper fluid.

3. The damper valve according to claim 1, wherein the through-channels in the valve body are able to be selected and/or blocked by the control disc in such a way that, in at least one direction of rotation of the control disc, the flow cross sections of the through-openings are added together or subtracted from one another.

4. The damper valve according to claim 1, wherein the number of rotational positions of the control disc corresponds to the square of the number of through-openings in the control disc.

5. The damper valve according to claim 1, wherein the rotational positions of the control disc are settable incrementally by the adjustment element, wherein the control disc is able to be moved into at least 4 rotational positions.

6. The damper valve according to claim 1, wherein the through-openings in the control disc and/or the through-channels in the valve body are arranged on different hole circles.

7. The damper valve according to claim 6, wherein the through-openings in the control disc and the through-channels in the valve body which are arranged on the same hole circle correspond or are spaced apart from one another depending on the rotational position of the control disc.

8. The damper valve according to claim 1, wherein at least two of the through-channels in the valve body have different flow cross sections.

9. The damper valve according to claim 1, wherein at least one or more through-channels in the valve body extend outwardly in a radial direction.

10. The damper valve according to claim 1, wherein the control disc is preloaded or able to be preloaded against the valve body by at least one spring element.

11. The damper valve according to claim 1, wherein at least one actuating part is connected to the adjustment element for conjoint rotation, wherein the actuating part is accessible from the outside.

12. The damper valve according to claim 1, wherein the adjustment element is in the form of an adjustment shaft which extends through the valve body and the control disc, wherein the control disc is arranged on the adjustment shaft for conjoint rotation and the valve body is rotationally decoupled from the adjustment shaft.

13. The damper valve according to claim 1, wherein at least one holding part is provided, into which the valve body is at least partially inserted, wherein the adjustment element extends through the holding part.

14. The damper valve according to claim 1, wherein the damper valve is a damper valve for a vibration damper of a vehicle.

15. The damper valve according to claim 1, wherein the control disc has at least two through-openings with different cross sections, in order to change the flow cross section of the damper fluid through the through-channels in the valve body.

16. The damper valve according to claim 1, wherein the rotational positions of the control disc are settable incrementally by the adjustment element, wherein the control disc is able to be moved into 6 to 14 rotational positions.

17. The damper valve according to claim 1, wherein the rotational positions of the control disc are settable incrementally by the adjustment element, wherein the control disc is able to be moved into at least 16 rotational positions.

18. The damper valve according to claim 1, wherein the through-openings in the control disc and/or the through-channels in the valve body are arranged on two different hole circles.

19. The damper valve according to claim 1, wherein at least one actuating part is connected to the adjustment element for conjoint rotation, wherein the actuating part is accessible from the outside and is rotatable by hand.

20. A vibration damper for a motorized vehicle, comprising:
at least one damper valve according to claim 1;
wherein the damper valve is fluidically connected or able to be fluidically connected to at least one working space and/or a compensation space of the vibration damper in order to set a damping force.
